(19) United States
(12) Patent Application Publication
(10) Pub. No.: US 2024/0354103 A1
(43) Pub. Date: Oct. 24, 2024

(54) PAGE DISPLAY METHODS AND APPARATUSES

(71) Applicant: BOE Technology Group Co., Ltd., Beijing (CN)

(72) Inventors: Kun LI, Beijing (CN); Sujia JIANG, Beijing (CN); Zhenyan ZHAO, Beijing (CN); Haixia ZHAO, Beijing (CN)

(21) Appl. No.: 18/579,855

(22) PCT Filed: Sep. 21, 2022
(86) PCT No.: PCT/CN2022/120091

§ 371 Date: Jan. 16, 2024

(30) Foreign Application Priority Data
Nov. 19, 2021 (CN) 202111401266.3

(51) Int. Cl. G06F 8/71

(52) U.S. Cl. CPC G06F 8/71

(57) ABSTRACT

The present disclosure provides a page display method and apparatus. The method includes: in response to a first trigger operation in a target application, acquiring a target cross-platform engine instance constructed in advance by a self-defined operation from a memory, where the first trigger operation is used to request a jump from a native page of the target application to a target cross-platform page; based on the target cross-platform engine instance, loading the target cross-platform page. In this case, there is only one cross-platform engine instance in the memory, reducing the occupation for the memory, optimizing the performance of the target application and improving the user experiences.

### TECHNICAL FIELD

The present disclosure relates to the field of computer technologies, and in particular to a page display method and apparatus.

### BACKGROUND

Flutter is a solution for a cross-platform User Interface (UI) in which a page developed based on Flutter, i.e. the Flutter page, can be run in the Android system and iOS system at the same time so as to achieve cross platform.

At present, when the Flutter page is loaded, it is required to create a Flutter engine instance to load the Flutter page using the Flutter engine instance. When a user uses an application, it may be needed to jump from a native page to the Flutter page several times. Each time the jump from the native page to the Flutter page is performed, a new Flutter engine instance needs to be created. Therefore, multiple Flutter engine instances are to be created, and as a result, there are multiple Flutter engine instances in a memory, occupying large memory and affecting user experiences.

### SUMMARY

In view of this, one of the objects of the present disclosure is to provide a page display method and apparatus.

According to a first aspect of embodiments of the present disclosure, there is provided a page display method, which includes:
in response to a first trigger operation in a target application, acquiring, from a memory, a target cross-platform engine instance constructed in advance by a self-defined operation, where the first trigger operation is used to request a jump from a native page of the target application to a target cross-platform page;
based on the target cross-platform engine instance, loading the target cross-platform page.

In an embodiment, the method further includes:
in response to a startup operation of the target application, constructing the target cross-platform engine instance by the self-defined operation of a cross-platform engine instance;
storing the target cross-platform engine instance into the memory.

In an embodiment, acquiring, from the memory, the target cross-platform engine instance constructed in advance by the self-defined operation includes:
acquiring, from the memory, a global variable corresponding to the target cross-platform engine instance, and based on the global variable, determining the target cross-platform engine instance in the memory, where the global variable is defined when the target cross-platform engine instance is constructed.

In an embodiment, the method further includes:
based on the target cross-platform engine instance, displaying a first preset page corresponding to the target application, wherein the first preset page is a home page corresponding to the target application.

In an embodiment, the method further includes:
in response to the startup operation of the target application, displaying a second preset page corresponding to the target application, where the second preset page is a startup page corresponding to the target application.

In an embodiment, the method further includes:
in response to determining that a second preset page corresponding to the target application has been displayed and a first preset page corresponding to the target application has not been displayed, displaying a third preset page.

In an embodiment, the method further includes:
in response to displaying the first preset page, removing the third preset page.

In an embodiment, the method further includes:
initializing the target cross-platform engine instance.

In an embodiment, the third preset page has the same display content as the second preset page.

In an embodiment, the target cross-platform engine instance includes a target Flutter engine instance.

According to a second aspect of embodiments of the present disclosure, there is provided a page display apparatus, which includes:
an instance acquiring module, configured to, in response to a first trigger operation in a target application, acquire, from a memory, a target cross-platform engine instance constructed in advance by a self-defined operation, where the first trigger operation is used to request a jump from a native page of the target application to a target cross-platform page;
a page displaying module, configured to, based on the target cross-platform engine instance, load the target cross-platform page.

In an embodiment, the apparatus further includes an instance constructing module:
the instance constructing module is configured to:
in response to a startup operation of the target application, construct the target cross-platform engine instance by the self-defined operation of a cross-platform engine instance;
store the target cross-platform engine instance into the memory.

In an embodiment, the instance acquiring module is configured to:
acquire, from the memory, a global variable corresponding to the target cross-platform engine instance, and based on the global variable, determine the target cross-platform engine instance in the memory, where the global variable is defined when the target cross-platform engine instance is constructed.

In an embodiment, the instance constructing module is further configured to:
based on the target cross-platform engine instance, display a first preset page corresponding to the target application, wherein the first preset page is a home page corresponding to the target application.

In an embodiment, the instance constructing module is further configured to:
in response to the startup operation of the target application, display a second preset page corresponding to the target application, where the second preset page is a startup page corresponding to the target application.

In an embodiment, the apparatus further includes a page processing module:
the page processing module is configured to:
in response to determining that a second preset page corresponding to the target application has been displayed and a first preset page corresponding to the target application has not been displayed, display a third preset page.

In an embodiment, the page processing module is further configured to:
in response to displaying the first preset page, remove the third preset page.

In an embodiment, the instance constructing module is further configured to: initialize the target cross-platform engine instance.

In an embodiment, the third preset page has the same display content as the second preset page.

In an embodiment, the target cross-platform engine instance includes a target Flutter engine instance.

According to a third aspect of embodiments of the present disclosure, there is provided a mobile terminal, which includes:
a processor;
a memory for storing processor-executable instructions;
wherein the processor is configured to:
in response to a first trigger operation in a target application, acquire, from a memory, a target cross-platform engine instance constructed in advance by a self-defined operation, where the first trigger operation is used to request a jump from a native page of the target application to a target cross-platform page;
based on the target cross-platform engine instance, load the target cross-platform page.

According to a fourth aspect of embodiments of the present disclosure, there is provided a computer readable storage medium, storing computer executable instructions, where the processor executes the computer executable instructions to perform the page display method mentioned in the first aspect or in various possible designs of the first aspect.

According to a fifth aspect of embodiments of the present disclosure, there is provided a computer program product, including computer programs, where the computer programs are executed by a processor to perform the page display method mentioned in the first aspect or in various possible designs of the first aspect.

The technical solutions provided by the embodiments of the present disclosure have the following beneficial effects.

In the embodiments of the present disclosure, in the process of the user using the target application, when receiving the first trigger operation, it indicates that a jump from the currently-displayed native page to the corresponding cross-platform page, i.e. the target cross-platform page, is required. In this case, a self-defined cross-platform engine instance, namely, the target cross-platform engine instance constructed in advance by a self-defined operation, may be called directly from the memory, such that the target cross-platform page is loaded by using the target cross-platform engine instance. In this way, the display of the cross-platform page can be achieved without creating a new cross-platform engine instance. In this case, there is only one cross-platform engine instance in the memory, reducing the occupation for the memory, optimizing the performance of the target application and improving the user experiences.

It should be understood that the above general descriptions and subsequent detailed descriptions are only illustrative and explanatory rather than limiting of the present disclosure.

### BRIEF DESCRIPTION OF DRAWINGS

To describe the technical solutions in the embodiments of the present disclosure more clearly, drawings required in descriptions of the embodiments of the present disclosure will be briefly introduced below. It is apparent that the drawings described below are merely some embodiments of the present disclosure and other drawings may be obtained by those of ordinary skill in the prior art based on these drawings in the embodiments of the present disclosure without making creative work.

FIG. 1 is a schematic diagram illustrating an existing page jump process according to an exemplary embodiment of the present disclosure.

FIG. 2 is a schematic diagram illustrating a page stacking according to an exemplary embodiment of the present disclosure.

FIG. 3 is a flowchart illustrating a page display method according to an exemplary embodiment of the present disclosure.

FIG. 4 is a schematic diagram illustrating a page jump according to an exemplary embodiment of the present disclosure.

FIG. 5 is a schematic diagram illustrating another page jump according to an exemplary embodiment of the present disclosure.

FIG. 6 is a flowchart illustrating another page display method according to an exemplary embodiment of the present disclosure.

FIG. 7 is a schematic diagram illustrating another page jump according to an exemplary embodiment of the present disclosure.

FIG. 8 is a flowchart illustrating another page display method according to an exemplary embodiment of the present disclosure.

FIG. 9 is a schematic diagram illustrating a display page of an application according to an exemplary embodiment of the present disclosure.

FIG. 10 is a hardware structure diagram illustrating a mobile terminal where a page display apparatus is located according to an exemplary embodiment of the present disclosure.

FIG. 11 is a structural block diagram illustrating a page display apparatus according to an exemplary embodiment of the present disclosure.

### DETAILED DESCRIPTION

The technical solutions of embodiments of the present disclosure will be described clearly and fully below in combination with drawings in the embodiments of the present disclosure. It is apparent that the described embodiments are merely some of embodiments of the present disclosure rather than all embodiments. Other embodiments obtained by those of ordinary skill in the art based on these embodiments in the present disclosure without making creative work shall all fall into the scope of protection of the present disclosure.

For ease of descriptions, the terms involved in the present disclosure will be firstly explained below.

Native page: Android page developed based on java and/or iOS page developed based on Objective-C.

Startup page: a system page displayed firstly in a startup process of an application.

Flutter: it is a cross-platform framework of a User Interface (UI) layer, which is mainly used to achieve service development of the UI layer. For example, a news list page, a news detail page, a personal information page or the like in a news client can be developed by using Flutter. But, if there is a piece of positioning information in the news to display a map to notify the user where the news occurs, a positioning function is to be used. This cannot be implemented by the Flutter, and needs to be implemented using a native function to call back to the Flutter layer.

Furthermore, when a Flutter page is loaded, it is required to start a Flutter Engine. When a service does not require a jump to the Android/iSO page, only one Flutter engine is needed in the running process of the application. But, when a service involves the functions such as photographing, positioning, pushing or the like, the Android/iOS native function is needed to achieve them. When a jump is performed from the Android/iOS page to the Flutter page, the Flutter defaults to start up another engine, and thus there are two engines in the memory at the same time. Due to service requirements, a jump from the Flutter page to the native page is subsequently required, and then callback to the Flutter page is continued, and thus, another engine will be generated. Correspondingly, there will be multiple engines in the memory.

The embodiments of the present disclosure will be detailed below.

In some embodiments, when an application is started up, a home page of the application is usually achieved by Flutter, that is, the home page is the Flutter page. Thus, it is defaulted that a Flutter engine instance is initialized, so that the home page is loaded using the Flutter engine instance. When the application involves a native function (e.g. positioning, or photographing using a camera or the like), it is required to jump from the Flutter page to a native page. Further, when the user inputs a relevant trigger operation, it indicates that a jump from the native page to a corresponding Flutter page is required. Since a default Flutter engine instance cannot be acquired, the Flutter engine instance is re-initialized to use a new Flutter engine instance to load the corresponding Flutter page.

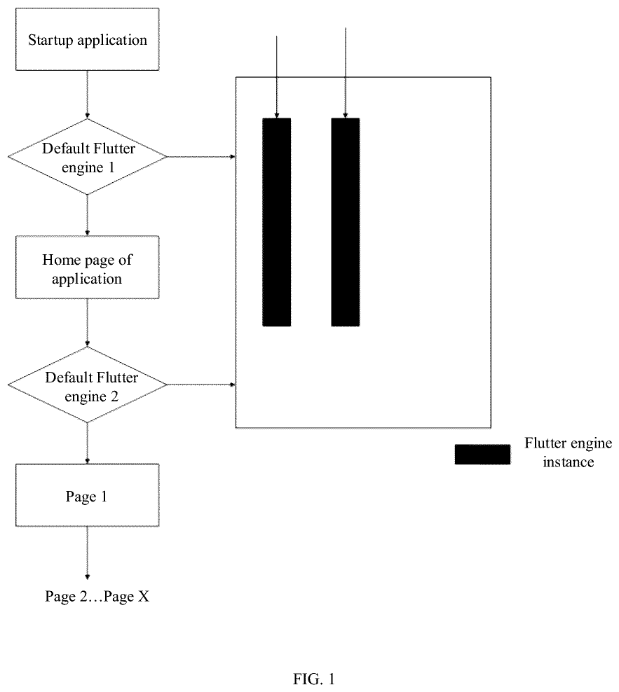

For example, as shown in FIG. 1, after the application is started up, it is defaulted to initialize a Flutter engine instance, namely, start up a Flutter engine 1, such that the home page of the application is loaded by using the Flutter engine 1. Further, when the Flutter engine 1 is started up, the Flutter engine 1 may be stored into the memory. In the process of the user using the application, when jumping from the native page to the Flutter page (i.e. a page 1), since the default engine instance is not available, that is, the Flutter engine 1 is not available, initialization is required to start up a new Flutter engine instance (i.e. a Flutter engine 2), such that the page 1 is loaded by using the Flutter engine 2. Further, when the Flutter engine 2 is started up, the Flutter engine 2 may be stored into the memory. At this time, there are two Flutter engine instances in the memory. Therefore, when the application involves a scenario of multiple jumps from the native page to the Flutter page, it is required to instantiate the Flutter engine several times, and as a result, there are multiple Flutter engine instances in the memory, occupying large memory and affecting the performance of the application.

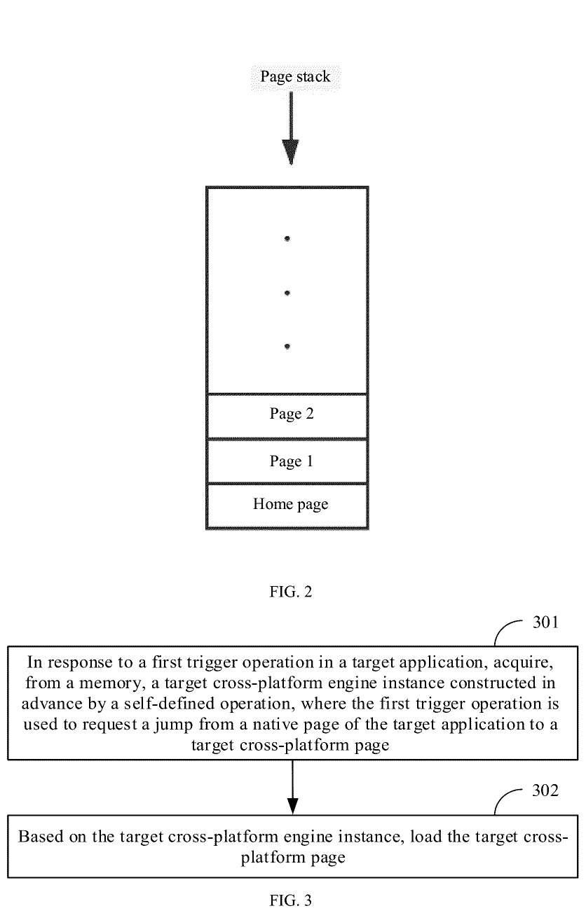

When the home page/page 1 is loaded, a routing mechanism pushes the home page/page 1 into a routing stack (as shown in FIG. 2). After being pushed into the stack, the home page/page 1 may occupy the memory all the time, and thus the Flutter engine 1/Flutter engine 2 cannot be released and also occupy the memory all the time.

For the above problem, one or more embodiments of the present disclosure provide a Flutter page loading method. In this method, when an application is started up, a Flutter engine instance is self-defined and initialized and then stored into a cache. The home page of the application is loaded by using the Flutter engine instance. Further, when a jump from the native page to the Flutter page is required subsequently, the Flutter engine instance in the memory is directly used to load the Flutter page, without creating a new Flutter engine instance. In this case, there is only one Flutter engine instance in the memory, reducing the occupation of the memory, effectively lowering the memory overhead and performance overhead, optimizing the performance of the application and improving the user experiences.

FIG. 3 is a flowchart illustrating a page display method according to an exemplary embodiment of the present disclosure. The method includes the following steps.

At step 301, in response to a first trigger operation in a target application, a target cross-platform engine instance constructed in advance by a self-defined operation is acquired from a memory, where the first trigger operation is used to request a jump from a native page of the target application to a target cross-platform page.

In this embodiment, in the process of a user using a target application on a mobile terminal, when the user wants to use a specific function provided by the target application, the user may input a corresponding trigger operation, i.e. the first trigger operation. When the specific function is achieved, a jump from the native page to a specific cross-platform page is required, and correspondingly, the first trigger operation is used to request a jump from the native page currently displayed by the target application to the target cross-platform page.

After the mobile terminal receives the first trigger operation input by the user, it indicates that a jump from the currently-displayed native page to the specific cross-platform page (i.e. a target specific cross-platform page) is required, namely, it indicates that a cross-platform page needs to be loaded. In this case, an existing target cross-platform engine instance is acquired from the memory such that the cross-platform page is loaded by using the target cross-platform engine instance.

The first trigger operation includes a click operation, a voice operation and a gesture operation and so on.

The target cross-platform engine instance is a cross-platform engine instance constructed in advance by executing a self-defined operation when the target application is started up. After the target cross-platform engine instance is stored into the memory, since the target cross-platform engine instance is self-defined, relevant instance information (e.g. an instance name) of the target cross-platform engine instance is known. Therefore, based on the relevant instance information, the target cross-platform engine instance can be acquired from the memory.

In an embodiment, the target cross-platform engine instance includes a target Flutter engine instance, and correspondingly, the cross-platform page includes a Flutter page, i.e. a page developed based on Flutter.

In an embodiment, the target application is an application developed based on Flutter, which involves one or more scenarios of jump from the native page to the Flutter page.

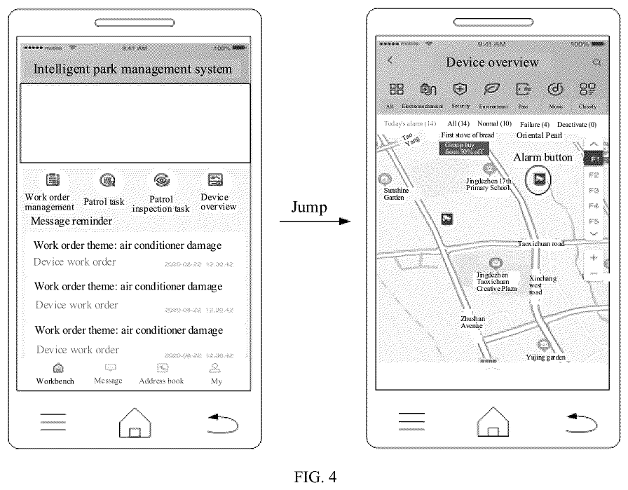

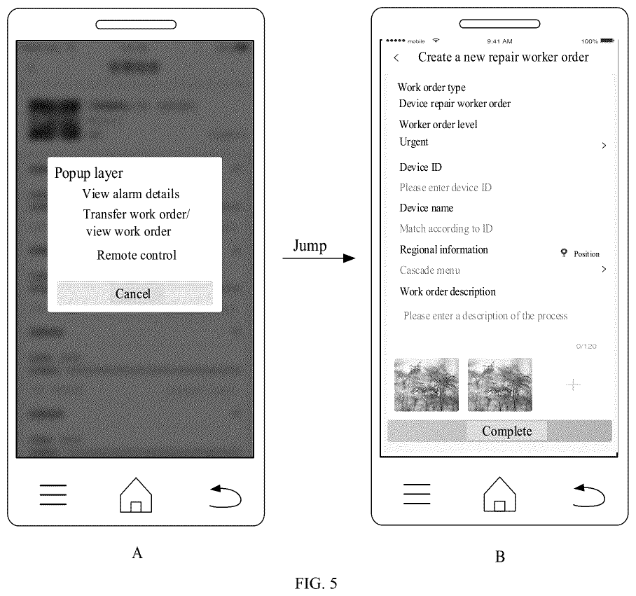

With a specific application scenario as an example, the target application includes a patrol inspection module. After entering the patrol inspection module, as shown in FIG. 4, the firstly-displayed page is the Flutter page. When a device overview button on the page is clicked, a jump is performed to a device overview page containing positioning. i.e. the native page, and thus the positioning of the device can be viewed in the device overview page. The device overview page displays an alarm button. When the user clicks the alarm button, it indicates that the first trigger operation is triggered, and thus a jump is performed to the corresponding alarm page, i.e. the Flutter page. When the user clicks a relevant button on the alarm page, the page displays a popup layer as shown in FIG. 5A. When the user clicks a transfer work order/view work order control on the popup layer, a jump is performed to a newly-created repair work order page shown in FIG. 5B (i.e. the Flutter page). When the user clicks a positioning control on the newly-created repair work order page, the target application jumps to a positioning page, and the positioning page jumps back to the Flutter page after positioning is selected, thus achieving a jump between the native page and the Flutter page.

In an embodiment, the target application includes a native layer and a cross-platform layer (e.g. the Flutter layer). When a jump is performed from the Flutter page to the native page, the mobile terminal sends first target page information to the native layer based on the cross-platform layer, such that the native layer jumps from the cross-platform page to the native page, where the first target page information includes a jump identifier and a target native page identifier. The jump identifier indicates performing page jump, and the target native page identifier indicates a native page identifier to be displayed. After the native layer receives the first target page information, it indicates that a jump from the currently-displayed cross-platform page to the target native page is required. In this case, a relevant page loading method is called to load the target native page corresponding to the target native page identifier.

The cross-platform layer may send the first target page information to the native layer through a platform channel (PlantformChannel), where the platform channel may be a method channel (MethodChannel).

Correspondingly, the process in which the native page jumps to the cross-platform page is contrary to the above process in which the cross-platform page jumps to the native page. That is, the native layer may send corresponding second target page information to the cross-platform layer through the platform channel, such that the cross-platform layer, after receiving the second target page information (it indicates that a jump from the currently-displayed native page to the target cross-platform page is required), invokes the target cross-platform engine instance to load the target cross-platform page.

At step 302, based on the target cross-platform engine instance, the target cross-platform page is loaded.

In this embodiment, when the target cross-platform engine instance is acquired from the memory, the target cross-platform page is loaded by directly using the target cross-platform engine instance, so as to jump from the currently-displayed page to the target cross-platform page, achieving the display of the cross-platform page.

In an embodiment, page information (e.g. a page identifier) corresponding to the target cross-platform page is acquired and then taken as an input parameter of the target cross-platform engine instance, such that the target cross-platform engine instance loads the corresponding cross-platform page.

Correspondingly, in a running process of the target application, it is possible to open multiple cross-platform pages. Thus, different cross-platform pages may be loaded by using the target cross-platform engine instance. When the target cross-platform engine instance loads different cross-platform pages, the page information corresponding to the cross-platform pages to be loaded is acquired, and then taken as an input parameter of the target cross-platform engine instance, such that the target cross-platform engine instance loads the corresponding cross-platform pages.

In an embodiment, since it is required to push the page of the target application into the routing stack upon opening the page, when one page in the routing stack is returned, the page can be directly acquired from the routing stack without re-loading. Correspondingly, when a jump is performed from the native page back to the target cross-platform page and the target cross-platform page is present in the routing stack, the target cross-platform page can be directly acquired from the routing stack without loading by calling the cross-platform engine instance again.

It can be understood that a page can be pushed into the stack upon being opened and can be pushed out of the stack upon being exited.

In this embodiment, since the target cross-platform engine instance is constructed in advance by a self-defined operation, the target cross-platform engine instance is a self-defined cross-platform engine instance rather than a cross-platform engine instance created by the system by default. After the target cross-platform engine instance is stored into the memory, the target cross-platform engine instance may be acquired from the memory. Thus, when a jump is performed from the native page to the cross-platform page, the target cross-platform engine instance can be directly called from the memory to load the corresponding cross-platform page. It is avoided that it is required to re-create a cross-platform engine instance to load the cross-platform page using the re-created cross-platform engine instance since the cross-platform engine instance created by the system by default is unavailable.

It can be known from the above that in the process of the user using the target application, when receiving the first trigger operation, it indicates that a jump from the currently-displayed native page to the corresponding cross-platform page (i.e. the target cross-platform page) is required. Thus, the self-defined cross-platform engine instance, i.e. the target cross-platform engine instance constructed in advance by the self-defined operation, may be directly called from the memory, such that the target cross-platform page can be loaded using the target cross-platform engine instance. In this way, the display of the cross-platform page is achieved without creating a new cross-platform engine instance. In this case, there is only one cross-platform engine instance in the memory, reducing the occupation for the memory, optimizing the performance of the target application and improving the user experiences.

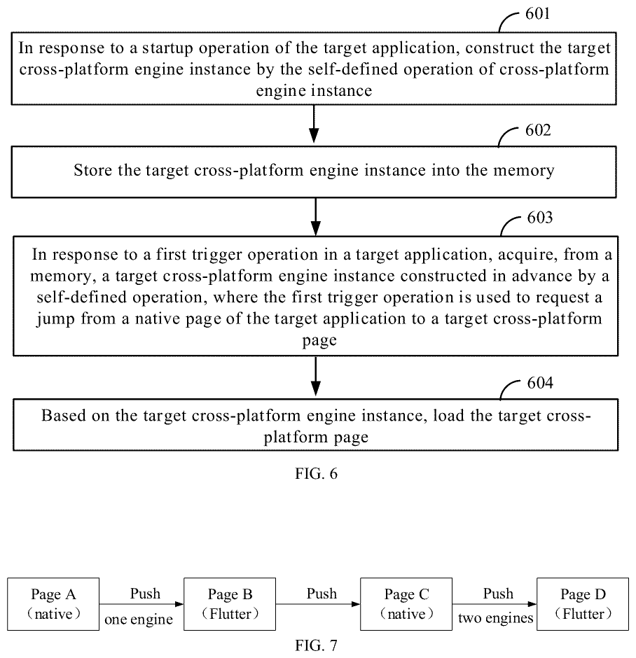

FIG. 6 is a flowchart illustrating another page display method according to an exemplary embodiment of the present disclosure. When the target application is started up, the target cross-platform engine instance is constructed such that the cross-platform page can be loaded using the target cross-platform engine instance. The process will be described in details below in combination with a specific embodiment. As shown in FIG. 6, the method includes the following steps.

At step 601, in response to a startup operation of the target application, the target cross-platform engine instance is constructed by the self-defined operation of a cross-platform engine instance.

In this embodiment, in response to receiving the startup operation of the target application input by the user, the target application is started up. When the target application is started up, the self-defined operation of cross-platform engine instance is executed to generate a self-defined cross-platform engine instance, i.e. the target cross-platform engine instance.

Executing the self-defined operation of cross-platform engine instance actually refers to a process in which a processor executes the generation codes of the self-defined cross-platform engine instance, where the generation codes are written in advance by relevant persons.

The startup operation includes a click operation, a voice operation and a gesture operation. For example, when the user clicks an icon corresponding to the target application, it indicates that the user inputs the corresponding startup operation.

In an embodiment, after the target method corresponding to the target application is executed, the target cross-platform engine instance is constructed using the self-defined operation of cross-platform engine instance.

The target method includes a main method.

In an embodiment, after the target cross-platform engine instance is constructed, relevant information (e.g. an instance name) of the target cross-platform engine instance is stored into a preset plugin table. The plugin table has a similar function to a registry. After the relevant information of the cross-platform engine instance is stored into the plugin table, the cross-platform page can be loaded using the cross-platform engine instance.

In this embodiment, in response to the startup operation of the target application, a second preset page corresponding to the target application is displayed in the startup process of the target application. The second preset page is a startup page corresponding to the target application.

In an embodiment, after the target cross-platform engine instance is constructed, the target cross-platform engine instance is initialized, namely, the target cross-platform engine instance is started up.

At step 602, the target cross-platform engine instance is stored into the memory.

In this embodiment, after the target cross-platform engine instance is constructed, the target cross-platform engine instance is stored into the memory. Thus, when the corresponding cross-platform page is loaded using the cross-platform engine instance subsequently, the target cross-platform engine instance in the memory can be directly used without re-creating a cross-platform engine instance.

In an embodiment, after the target cross-platform engine instance is constructed, the target cross-platform engine instance is initialized and the initialized target cross-platform engine instance is added to the memory.

In an embodiment, the target cross-platform engine instance may be added to a cache, such that the target cross-platform engine instance can be quickly acquired from the cache when the target cross-platform engine instance is called subsequently, thereby increasing the page loading speed.

In an embodiment, to help acquire the target cross-platform engine instance from the memory, i.e. the cache, it is required to define a global variable corresponding to the target cross-platform engine instance during the construction of the target cross-platform engine instance, and store the global variable into the memory. In an embodiment, the global variable may be stored into the cache, and hence, the global variable can be acquired from the memory when the target cross-platform engine instance is called subsequently, and further, the target cross-platform engine instance is acquired from a position pointed to by the global variable.

Defining the global variable actual refers to executing the codes for defining the global variable.

The codes for creating the self-defined cross-platform engine instance and defining the global variable and storing them into the cache are as follows:

```
  @objc func getFlutterEngine( )−>FlutterEngine{
  /*
  search for Engine variable in the cache; if not present, performing one
initialization; if present, directly return to acquire
  */
  if (flutterEngine == nil) {
  /*
  initialize the self-defined Engine
  */
  let flutterEngin = FlutterEngine(name:“park.flutter”, project:nil);
  /*
  start up engine
  */
  flutterEngin.run(withEntrypoint:nil);
  GeneratedPluginRegistrant.register(with:flutterEngin);
  /*
  define global variable to assign Engine and store into memory
  */
  flutterEngine = flutterEngin;
  }
  /*
  return Engine in the memory
  /*
  return flutterEngine;
  }
```

In an embodiment, based on the target cross-platform engine instance, a first preset page corresponding to the target application is displayed.

In this embodiment, after the target cross-platform engine instance is constructed, the target cross-platform engine instance is initialized and the first preset page corresponding to the target application is loaded using the initialized target cross-platform engine instance.

The first preset page is a home page corresponding to the target application, namely, the first page displayed after the startup page.

The codes for acquiring the target cross-platform engine instance from the cache and loading the home page using the target cross-platform engine instance are as follows:

```
  /*
  acquire Engine object from the cache
  */
  self.flutterEngine = self .getFlutterEngine(;
  /*
  use the self-defined engine, i.e. the target cross-platform engine instance to
initialize the home page of the application
  */
  self.flutterController = FlutterViewController(engine:self.flutterEngine,
nibName:nil, bundle:nil);
  let image = UllmageView.init(image:Ullmage.init(named:“lanch._ img));
  image.frame = CGRect.init(origin: CGPoint.init(x: 0, y: 0) , size:
self.window.bounds.size);
  image.contentMode = .scaleAspectFill;
  self.flutterController!.view.addSubview(image);
  /*
  start up the home page
  */
  let navigationController =
TaoWenLvNavigationController.init(rootViewController: self.flutterController!)
  self.window.rootViewController = navigationController;
  self.window.backgroundColor = UlColor.white;
  self.flutterController?.fd prefersNavigationBarHidden = true;
  BOERouter<AnyObject>.shared( ).navigationController = navigationController;
```

At step 603, in response to a first trigger operation in a target application, a target cross-platform engine instance constructed in advance by a self-defined operation is acquired from a memory, where the first trigger operation is used to request a jump from a native page of the target application to a target cross-platform page.

In this embodiment, a global variable corresponding to the target cross-platform engine instance is acquired from the memory and based on the global variable, the target cross-platform engine instance is determined from the memory, namely, the target cross-platform engine instance is acquired from the position pointed to by the global variable. The global variable is defined when the target cross-platform engine instance is constructed, such that a new cross-platform page, i.e. the target cross-platform page, is initialized by using the target cross-platform engine instance. The specific implementation is as follows:

```
  /*
  acquire Engine from the cache pool
  */
  AppDelegate *ad = (AppDelegate *)[UlApplication sharedApplication].
delegate;
  FlutterEngine *engine = [ad getFlutterEngine];
  engine.viewController = nil;
  /*
  use the cached Engine, i.e. the target cross-platform engine instance to initialize
a new Flutter page
  */
  FlutterViewController *flutterController = [[FlutterViewController
alloc]initWithEngine:engine nibName:nil bundle:nil];
  flutterController.fd prefersNavigationBarHidden = YES;
  [self .navigationController pushViewController :flutterController animated:
YES];
```

At step 604, based on the target cross-platform engine instance, the target cross-platform page is loaded.

In this embodiment, for the existing native application, most of the pages are native pages, and when a new service based on Flutter requirement is developed, it is required to embed the Flutter page into the original page. Therefore, when the user uses the application, a service of jumping from the native page to the Flutter page is involved. Each time a jump is performed from the native page to the Flutter page (as shown in FIG. 7, a jump from the page A to page B and a jump from page C to page D), one Flutter engine is to be started up. In this case, there are multiple Flutter engines in the memory, which consumes much system resource. To avoid presence of multiple Flutter engines in the memory, in the present disclosure, the Flutter engine defaulted by the system is discarded but the self-defined controllable Flutter engine is adopted and stored into the cache pool. When a jump from the native page to the Flutter page is required subsequently, the Flutter engine may be acquired from the cache pool to load the Flutter page using the Flutter engine. In this case, there is only one Flutter engine during the running period of the application. Therefore, the problem of memory and resource consumption is addressed and the human labour development costs are saved while the cross-platform is achieved.

In this embodiment, when the target application is started up, the system-defaulted cross-platform engine is not started up but a self-defined controllable cross-platform engine instance, i.e. the target cross-platform engine instance, is created by executing a self-defined operation of cross-platform engine instance. Thus, the cross-platform page can be loaded using the target cross-platform engine instance. In a scenario of a jump from the native page to the cross-platform page, the corresponding cross-platform page can be loaded by using the target cross-platform engine instance, without creating a new cross-platform engine instance. In this case, there is only one cross-platform engine instance in the memory. As a result, the memory occupation and resource consumption are reduced and the user experiences are improved while the cross-platform is achieved.

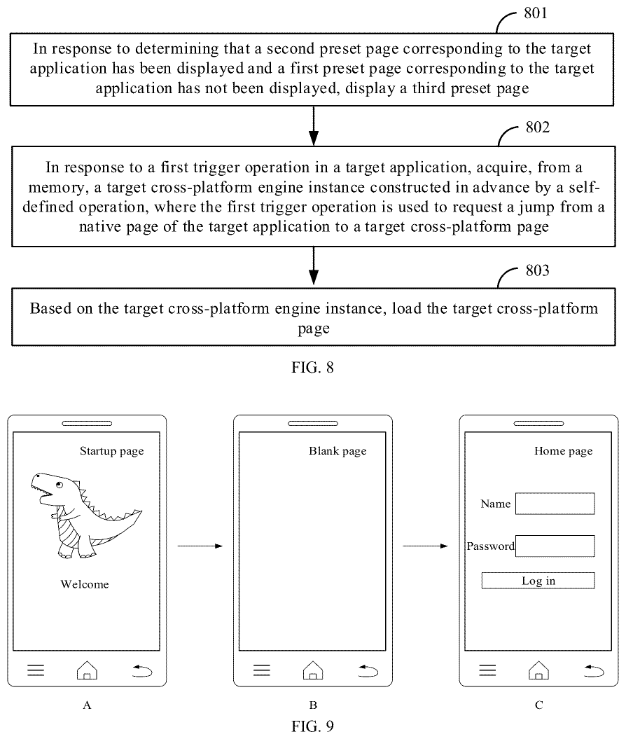

FIG. 8 is a flowchart illustrating another page display method according to an exemplary embodiment of the present disclosure. To avoid a white screen problem, when the target cross-platform engine instance is initialized, a corresponding page is inserted. The process will be detailed below in combination with a specific embodiment. As shown in FIG. 8, the method may include the following steps.

At step 801, in response to determining that a second preset page corresponding to the target application has been displayed and a first preset page corresponding to the target application has not been displayed, a third preset page is displayed.

In this embodiment, since the target cross-platform engine instance is generated based on relevant self-defined codes, namely, the target cross-platform engine instance is a self-defined cross-platform engine instance. Compared with the time required for initialization of the default cross-platform engine instance, the time required for initialization of the self-defined cross-platform engine instance is longer. In this case, when the self-defined cross-platform engine instance is initialized, the startup page (e.g., the startup page shown in FIG. 9A), i.e. the second preset page has been displayed, but the first preset page (e.g., the home page shown in FIG. 9C. i.e. a login page) to be loaded using the cross-platform engine instance has not been rendered. As a result, a blank page (e.g., a blank page shown in FIG. 9B) appears for a certain period of time, which greatly affects the user experiences.

In an embodiment, the first preset page (the home page), the second preset page (the startup page) and the third preset page are all stored in the target application, i.e. at the corresponding positions in an installation package corresponding to the target application. In other words, the display information (e.g. a display picture) corresponding to the first preset page is stored at a first preset position in the installation package, the display information corresponding to the second preset page is stored at a second preset position in the installation packet, and the display information corresponding to the third preset page is stored at a third preset position in the installation packet.

When a preset page is to be loaded, that is, when the display information corresponding to the preset page is to be loaded, it can be acquired from the corresponding preset position based on a relevant loading method, i.e. function. For example, when the display information corresponding to the third preset page is loaded, the display information is acquired from the third preset position by calling a relevant loading method and then displayed.

The first preset position, the second preset position and the third preset position can be set based on actual requirements and will not be limited herein.

Furthermore, in an embodiment, after the target application is installed to the mobile terminal, the display information corresponding to the second preset page stored at the second preset position is stored to a specific position in the mobile terminal, such that the display information can be acquired from the specific position by using the native layer subsequently.

To avoid presence of a blank page resulting from a too long time of initialization of the target cross-platform engine instance, when the second preset page has been displayed but the first preset page has not been displayed, i.e. when the target cross-platform engine instance is initialized, the third preset page is inserted such that the mobile terminal displays the third preset page rather than the blank page, thereby avoiding the confusion of the user about the white screen and ensuring user experiences.

In an embodiment, the third preset page has the same display content as the second preset page.

In an embodiment, to ensure senseless experiences of the user, the display content of the third preset page may be the same as that of the second preset page. When the target cross-platform engine instance is initialized, a picture same as the startup page may be displayed on the top window of the mobile terminal, i.e. on the topmost picture layer of the currently-displayed page, such that the user can see the same content as the startup page, achieving senseless switching.

In this embodiment, to avoid affecting the display of the first preset page, the third preset page is to be removed. Therefore, whether to remove the third preset page can be determined based on the following two manners.

One manner is that, the third preset page is removed in response to displaying the first preset page.

In an embodiment, when the first preset page is to be displayed, it indicates that the target cross-platform engine instance has been initialized and the first preset page can be loaded by using the target cross-platform engine instance. Thus, it is not required to continue displaying the third preset page but remove it, namely, the picture same as the startup page and displayed on the current page is removed to avoid affecting the display of the first preset page.

The other manner is that, in response to reaching a target display time corresponding to the third preset page, the third preset page is removed, where the target display time indicates a total time length for which the third preset page is displayed.

In an embodiment, acquiring a display time corresponding to the third preset page includes: counting time starting from the display of the third preset page to acquire a current display time. When it is determined that the current display time is greater than or equal to the target display time corresponding to the third preset page, it indicates that the display of the third preset page can be stopped, and thus the third preset page is removed, so as to avoid affecting the display of the first preset page.

The target display time can be set based on actual requirements. For example, the target display time can be set to 1.5 seconds. Accordingly, the target display time may be stored at a specified position corresponding to the target application, for example, the target display time is stored in a loading method associated with loading of the third preset page.

At step 802, in response to a first trigger operation in a target application, a target cross-platform engine instance constructed in advance by a self-defined operation is acquired from a memory, where the first trigger operation is used to request a jump from a native page of the target application to a target cross-platform page.

At step 803, based on the target cross-platform engine instance, the target cross-platform page is loaded.

In this embodiment, when the target cross-platform engine instance is initialized, that is, when the second preset page has been displayed but the first preset page has not been rendered, a transition page, i.e. the third preset page, is displayed to avoid the white screen problem. When the first preset page can be displayed, the display of the third preset page is stopped to achieve a normal display of the first preset page. Thus, the transition to the first preset page can be successfully achieved, ensuring senseless experience of the users and improving the use satisfaction of the users.

Corresponding to the above method embodiments, the present disclosure further provides an embodiment of a page display apparatus and a terminal to which the page display apparatus is applied.

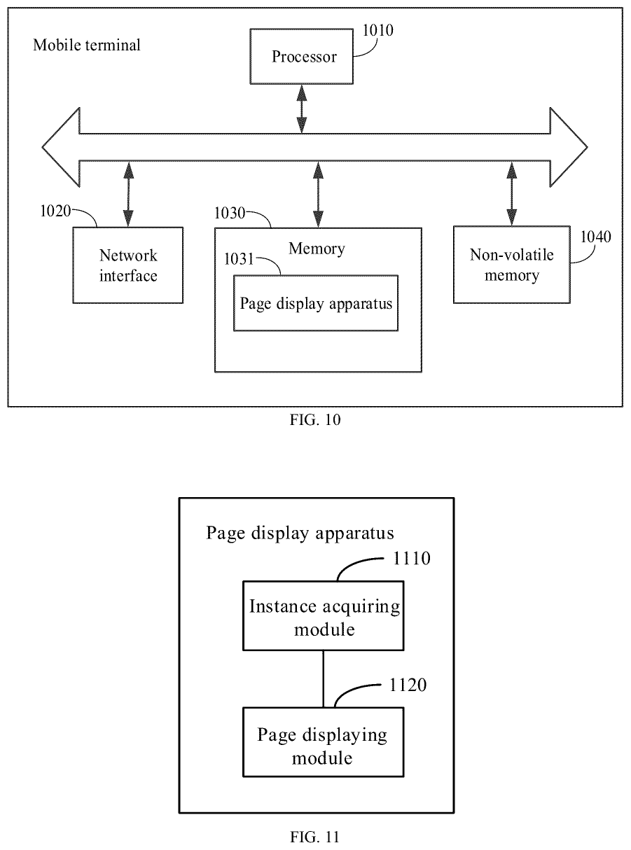

In the embodiments of the present disclosure, the page display apparatus may be applied to a mobile terminal, such as a smart phone or a tablet computer or the like. The apparatus embodiments can be implemented by software or by combination of software and hardware. With software implementation as an example, as a logical apparatus, the apparatus is formed by using a processor where the apparatus is located to read the corresponding computer program instructions in a non-volatile memory into the memory for running. From a hardware level, as shown in FIG. 10, it is a hardware structure diagram illustrating a mobile terminal where the page display apparatus is located according to an embodiment of the present disclosure. In addition to a processor 1010, a memory 1030, a network interface 1020 and a non-volatile memory 1040 shown in FIG. 10, the mobile terminal where the page display apparatus 1031 is located in the embodiments may further include other hardware based on actual functions of the mobile terminal, which will not be repeated herein.

FIG. 11 is a block diagram illustrating a page display apparatus according to an exemplary embodiment of the present disclosure. The apparatus includes:
an instance acquiring module 1110, configured to, in response to a first trigger operation in a target application, acquire a target cross-platform engine instance constructed in advance by a self-defined operation from a memory, where the first trigger operation is used to request a jump from a native page of the target application to a target cross-platform page;
a page displaying module 1120, configured to, based on the target cross-platform engine instance, load the target cross-platform page.

In an embodiment, the target cross-platform engine instance includes a target Flutter engine instance.

In another embodiment of the present disclosure, on the basis of the embodiment of FIG. 11, the page display apparatus further includes an instance constructing module.

The instance constructing module is configured to:
before, in response to the first trigger operation in the target application, the target cross-platform engine instance constructed in advance by the self-defined operation is acquired from the memory, in response to a startup operation of the target application, construct the target cross-platform engine instance by a self-defined operation of cross-platform engine instance;
store the target cross-platform engine instance into the memory.

In any embodiment, the instance acquiring module 1110 is configured to:
acquire a global variable corresponding to the target cross-platform engine instance from the memory, and based on the global variable, determine the target cross-platform engine instance in the memory, where the global variable is defined when the target cross-platform engine instance is constructed.

In this embodiment, the instance constructing module is further configured to:
after storing the target cross-platform engine instance into the memory, based on the target cross-platform engine instance, display a first preset page corresponding to the target application, where the first preset page is a home page corresponding to the target application.

In this embodiment, the instance constructing module is further configured to:
in response to the startup operation of the target application, display a second preset page corresponding to the target application, where the second preset page is a startup page corresponding to the target application.

In this embodiment, the instance constructing module is further configured to:
after constructing the target cross-platform engine instance by the self-defined operation of cross-platform engine instance, initialize the target cross-platform engine instance.

In another embodiment of the present disclosure, on the basis of the embodiment shown in FIG. 11, the page display apparatus further includes a page processing module.

The page processing module is configured to:
in response to determining that a second preset page corresponding to the target application has been displayed and a first preset page corresponding to the target application has not been displayed, display a third preset page.

In this embodiment, the page processing module is further configured to:
in response to displaying the first preset page, remove the third preset page.

In an embodiment, the third preset page has the same display content as the second preset page.

The specific implementation process of the functions and effects of the modules in the above apparatus can be referred to the implementation process of the corresponding steps in the above method and will not be repeated herein.

Correspondingly, the present disclosure further provides a mobile terminal which includes a processor, and a memory for storing processor-executable instructions, where the processor is configured to:
in response to a first trigger operation in a target application, acquire a target cross-platform engine instance constructed in advance by a self-defined operation from a memory, where the first trigger operation is used to request a jump from a native page of the target application to a target cross-platform page;
based on the target cross-platform engine instance, load the target cross-platform page.

An embodiment of the present disclosure provides a computer readable storage medium, storing computer program codes, where the computer program codes are executed by a processor to perform the steps of the above method.

An embodiment of the present disclosure further provides a computer program product, including computer programs, where the computer programs are executed by a processor to perform the steps of the above method.

Since the apparatus embodiments substantially correspond to the method embodiments, a reference may be made to part of the descriptions of the method embodiments for the related part. The apparatus embodiments described above are merely illustrative, where the units described as separate members may be or not be physically separated, and the members displayed as units may be or not be physical units, i.e., may be located in one place, or may be distributed to a plurality of network units. Part or all of the modules may be selected according to actual requirements to implement the objectives of the solutions in the embodiments. Those of ordinary skill in the art may understand and carry out them without creative work.

It shall be noted that the relational terms such as “first” and “second” used herein are merely intended to distinguish one entity or operation from another entity or operation rather than to require or imply any such actual relation or order existing between these entities or operations. Also, the term “including”, “containing” or any variation thereof is intended to encompass non-exclusive inclusion, so that a process, method, article or device including a series of elements includes not only those elements but also other elements not listed explicitly or those elements inherent to such a process, method, article or device. Without more limitations, an element defined by the statement “including a . . . ” shall not be precluded to include additional same elements present in a process, method, article or device including the elements.

The above are detailed descriptions of the method and the apparatus provided according to the embodiments of the present disclosure. Specific examples are used herein to set forth the principles and the implementing methods of the present disclosure, and the descriptions of the above embodiments are only meant to help understanding of the method and the core idea of the present disclosure. Meanwhile, those of ordinary skill in the art may make alterations to the specific embodiments and the scope of application in accordance with the idea of the present disclosure. In conclusion, the contents of the present specification shall not be interpreted as limiting to the present disclosure.

1. A page display method, comprising:
in response to a first trigger operation in a target application, acquiring, from a memory, a target cross-platform engine instance constructed in advance by a self-defined operation, wherein the first trigger operation is used to request a jump from a native page of the target application to a target cross-platform page; and
based on the target cross-platform engine instance, loading the target cross-platform page.

2. The method of claim 1, further comprising:
in response to a startup operation of the target application, constructing the target cross-platform engine instance by the self-defined operation of a cross-platform engine instance; and
storing the target cross-platform engine instance into the memory.

3. The method of claim 2, wherein acquiring, from the memory, the target cross-platform engine instance constructed in advance by the self-defined operation comprises:
acquiring, from the memory, a global variable corresponding to the target cross-platform engine instance, and
based on the global variable, determining the target cross-platform engine instance in the memory,
wherein the global variable is defined when the target cross-platform engine instance is constructed.

4. The method of claim 2, further comprising:
based on the target cross-platform engine instance, displaying a first preset page corresponding to the target application, wherein the first preset page is a home page corresponding to the target application.

5. The method of claim 2, further comprising:
in response to the startup operation of the target application, displaying a second preset page corresponding to the target application, wherein the second preset page is a startup page corresponding to the target application.

6. The method of claim 1, further comprising:
in response to determining that a second preset page corresponding to the target application has been displayed and a first preset page corresponding to the target application has not been displayed, displaying a third preset page.

7. The method of claim 6, further comprising:
in response to displaying the first preset page, removing the third preset page.

8. The method of claim 2, further comprising:
initializing the target cross-platform engine instance.

9. The method of claim 6, wherein the third preset page has same display content as the second preset page.

10. The method of claim 1, wherein the target cross-platform engine instance comprises a target Flutter engine instance.

11. (canceled)

12. A mobile terminal, comprising a memory, a processor, and computer programs stored in the memory and run on the processor, wherein the processor executes the programs to perform operations comprising:
in response to a first trigger operation in a target application, acquiring, from a memory, a target cross-platform engine instance constructed in advance by a self-defined operation, wherein the first trigger operation is used to request a jump from a native page of the target application to a target cross-platform page; and
based on the target cross-platform engine instance, loading the target cross-platform page.

13. The mobile terminal of claim 12, wherein the operations further comprising:
in response to a startup operation of the target application, constructing the target cross-platform engine instance by the self-defined operation of a cross-platform engine instance; and
storing the target cross-platform engine instance into the memory.

14. The mobile terminal of claim 13, wherein acquiring, from the memory, the target cross-platform engine instance constructed in advance by the self-defined operation comprises:
acquiring, from the memory, a global variable corresponding to the target cross-platform engine instance, and
based on the global variable, determining the target cross-platform engine instance in the memory,
wherein the global variable is defined when the target cross-platform engine instance is constructed.

15. The mobile terminal of claim 13, wherein the operations further comprising:
based on the target cross-platform engine instance, displaying a first preset page corresponding to the target application, wherein the first preset page is a home page corresponding to the target application.

16. The mobile terminal of claim 13, wherein the operations further comprising:
in response to the startup operation of the target application, displaying a second preset page corresponding to the target application, wherein the second preset page is a startup page corresponding to the target application.

17. The mobile terminal of claim 12, wherein the operations further comprising:
in response to determining that a second preset page corresponding to the target application has been displayed and a first preset page corresponding to the target application has not been displayed, displaying a third preset page.

18. The mobile terminal of claim 17, wherein the operations further comprising:
in response to displaying the first preset page, removing the third preset page.

19. The mobile terminal of claim 13, wherein the operations further comprising:
initializing the target cross-platform engine instance.

20. The mobile terminal of claim 17, wherein the third preset page has same display content as the second preset page.

21. The mobile terminal of claim 12, wherein the target cross-platform engine instance comprises a target Flutter engine instance.
